(19) United States
(12) Patent Application Publication
(10) Pub. No.: US 2014/0272819 A1
(43) Pub. Date: Sep. 18, 2014

(54) COMPUTER-IMPLEMENTED LANGUAGE HEURISTICS

(71) Applicant: CHINESE CUBES CO. LTD., Taipei (TW)

(72) Inventor: Ming-Yi Hoo, Taipei (TW)

(73) Assignee: Chinese Cubes Co. Ltd., Taipei (TW)

(21) Appl. No.: 13/831,869

(22) Filed: Mar. 15, 2013

(51) Int. Cl. G09B 19/06

(52) U.S. Cl. CPC G09B 19/06
USPC 434/157

(57) ABSTRACT

A linguistic phrase including a plurality of adjacently positioned characters arranged in a first sequence may be displayed. A first command may be received to obscure the linguistic phrase by separating the plurality of adjacently positioned characters into constituent characters In response to receiving the first command, the constituent characters may be displayed separate from each other to obscure the linguistic phrase. A second command may be received to combine at least two of the constituent characters to form a particular linguistic phrase including a number of adjacently positioned characters arranged in a particular sequence. Validity of the particular linguistic phrase may be evaluated. Upon determining that the particular linguistic phrase is valid, the particular linguistic phrase may be displayed including the number of adjacently positioned characters arranged in the particular sequence.

### BACKGROUND

The Chinese language is unique since each Chinese character by itself has an independent and complete meaning, and the character form of each Chinese character does not vary with tenses or parts of speech in Chinese grammar. One way to learn the Chinese language is to use Chinese characters to make Chinese phrases and sentences so as to gain an understanding of Chinese words, grammar, reading, and conversation.

### SUMMARY

This Summary does not in any way limit the scope of the claimed subject matter.

In one embodiment, a computer-implemented method is described. The method may include displaying a linguistic phrase comprising a plurality of adjacently positioned characters arranged in a first sequence, receiving a first command to obscure the linguistic phrase by separating the plurality of adjacently positioned characters into constituent characters, and in response to receiving the first command, displaying the constituent characters separate from each other to obscure the linguistic phrase. The method may further include receiving a second command to combine at least two of the constituent characters to form a particular linguistic phrase comprising a plurality of adjacently positioned characters arranged in a particular sequence, evaluating validity of the particular linguistic phrase, and upon determining that the particular linguistic phrase is valid, displaying the particular linguistic phrase comprising the plurality of adjacently positioned characters arranged in the particular sequence.

The method may further include receiving a command to access information associated with a particular one of the constituent characters. The method may further include modifying the particular one of the constituent characters in response to receiving the command.

The particular one of the constituent characters may comprise of a particular Chinese character, and the modifying may include displaying an English translation of the particular Chinese character.

The particular one of the constituent characters may comprise of a particular Chinese character, and the modifying may include displaying a Pinyin representation of the particular Chinese character.

The particular one of the constituent characters may comprise of a particular traditional Chinese character, and the modifying may include displaying a simplified representation of the particular traditional Chinese character.

The particular one of the constituent characters may comprise of a particular Chinese character, and the method may further include playing an audible Chinese pronunciation of the particular Chinese character, and displaying a listing comprising a plurality of valid linguistic phrases that may be formed using the displayed constituent characters in response to receiving the command.

The particular one of the constituent characters may comprise of a particular Chinese character, and the method may further include displaying a stroke animation for writing the particular Chinese character.

Each of the constituent characters may comprise of a particular Chinese character, and the method may further include receiving a command to access information associated with one of the linguistic phrase and the particular linguistic phrase, and playing an audible Chinese pronunciation of the particular Chinese character of the one of the linguistic phrase and the particular linguistic phrase.

In another embodiment, a computing device is described. The computing device may include a display device, a non-transitory computer-readable medium having sets of instructions stored thereon, and a computer processor in communication with the display device and the non-transitory computer-readable medium. The sets of instructions when executed by the computer processor, may cause the computer processor to display, on the display device, a linguistic phrase comprising a plurality of adjacently positioned characters arranged in a first sequence, receive a first command to obscure the linguistic phrase by separating the plurality of adjacently positioned characters into constituent characters, in response to receiving the first command, display, on the display device, the constituent characters separate from each other to obscure the linguistic phrase.

The sets of instructions may further cause the computing device to receive a second command to combine at least two of the constituent characters to form a particular linguistic phrase comprising a plurality of adjacently positioned characters arranged in a particular sequence, evaluate validity of the particular linguistic phrase, and upon determining that the particular linguistic phrase is valid, display, at the display device, the particular linguistic phrase comprising the plurality of adjacently positioned characters arranged in the particular sequence.

In a further embodiment, a non-transitory computer-readable medium is described. The sets of instructions when executed by a computer, may cause the computer to display a linguistic phrase comprising a plurality of adjacently positioned characters arranged in a first sequence, receive a first command to obscure the linguistic phrase by separating the plurality of adjacently positioned characters into constituent characters, in response to receiving the first command, display the constituent characters separate from each other to obscure the linguistic phrase, receive a second command to combine at least two of the constituent characters to form a particular linguistic phrase comprising a plurality of adjacently positioned characters arranged in a particular sequence, evaluate validity of the particular linguistic phrase, and upon determining that the particular linguistic phrase is valid, display the particular linguistic phrase comprising the plurality of adjacently positioned characters arranged in the particular sequence.

### BRIEF DESCRIPTION OF THE DRAWINGS

A further understanding of the nature and advantages of the present invention may be realized by reference to the remaining portions of the specification, and the drawings, wherein like reference numerals are used throughout to refer to similar components. In some instances, a sub-label may be associated with a reference numeral to denote one of multiple similar components. When reference is made to a reference numeral without specification to an existing sub-label, it is intended to refer to all such multiple similar components.

FIG. 1 shows a first example screenshot of an example user interface.

FIG. 2 shows a second example screenshot of the interface of FIG. 1.

FIG. 3 shows a third example screenshot of the interface of FIG. 1.

FIG. 4 shows a fourth example screenshot of the interface of FIG. 1.

FIG. 5 shows a fifth example screenshot of the interface of FIG. 1.

FIG. 6 shows a portion of the screenshot of FIG. 5.

FIG. 7 shows the screenshot of FIG. 5 with first modification.

FIG. 8 shows the screenshot of FIG. 5 with second modification.

FIG. 9 shows a sixth example screenshot of the interface of FIG. 1.

FIG. 10 shows a seventh example screenshot of the interface of FIG. 1.

FIG. 11 shows a portion of the screenshot of FIG. 10.

FIG. 12 shows the screenshot of FIG. 10 with first modification.

FIG. 13 shows the screenshot of FIG. 10 with second modification.

FIG. 14 shows the screenshot of FIG. 10 with third modification.

FIG. 15 shows the screenshot of FIG. 10 with fourth modification.

FIG. 16 shows an eighth example screenshot of the interface of FIG. 1.

FIG. 17 shows a ninth example screenshot of the interface of FIG. 1.

FIG. 18 shows a tenth example screenshot of the interface of FIG. 1.

FIG. 19 shows an example method in accordance with the present disclosure.

FIG. 20 shows an example networked computing environment.

FIG. 21 shows an example computing system or device.

### DETAILED DESCRIPTION

The Chinese language is typically considered one of the most difficult languages to learn for native English speakers, and speakers of other languages. This may at least be a consequence of fundamental differences between respective writing systems, phonology, grammar, etc. For example, while the modern English uses a twenty-six letter alphabetic writing system, the Mandarin Chinese employs a logographic writing system consisting of many thousands of distinct characters. This may be perceived as an overwhelming and insurmountable hurdle for the Chinese language learner who, in attempt to “shortcut” study of a large number of Chinese characters, may instead elect to solely study common Chinese terms or phrases to obtain conversational and/or written proficiency. Such a shortcut, however, may preclude the learner from grasping essential aspects of the Chinese language. For example, the historical and cultural meaning of a particular Chinese character used to form a particular phrase may be lost to the learner when only the phrase in its entirety is studied. In another example, it may be difficult for the learner to determine the meaning of an unfamiliar Chinese word, without at least a minimal understanding of at least one constituent character of the word.

Despite such issues, many non-native Chinese language learners continue to subscribe to the above-mentioned “shortcut” for learning Chinese. It is contemplated, however, that this seemingly incomplete tactic is not without value, and that it may be desirable to provide the native English speaker a tool to selectively study both Chinese characters and Chinese terms or phrases within a single, interactive computing environment. For example, referring now to FIG. 1, an example user interface 100 is shown in accordance with the present disclosure. In particular, FIG. 1 shows a first example screenshot 102 of the interface 100. In general, the interface 100 may be wholly or at least partially implemented on or by a special-purpose computing system or device 104. An example of such a computing system or device is described in further detail below in connection with at least FIGS. 20-21.

In practice, a particular user, or Chinese language learner, may interact with the interface 100 to selectively study both Chinese characters and Chinese terms or phrases within a single, interactive computing environment. Here, it is contemplated that at least one of the interface 100 and device 104 may be configured to support or otherwise implement any number and type of HMI (Human-Machine Interaction). For example, at least the interface 100 may be configured to support “point and click” input actions or gestures. An example of a “point and click” input action may include a user moving a pointer to a certain location within the interface 100, and then pressing a button on a pointing device. In another example, at least the interface 100 may be configured to support “touch-input” gestures. An example of “touch-input” gesture may include a user executing a “pinch to zoom” gesture, a “scroll” gesture, a “select” gesture, a “flick” gesture, etc. In this example, a physical screen 106 of the device 104 may comprise of a touch sensitive surface. In another example, the interface 100 and/or device 104 may be configured to support VIC (Voice Input Control). Still other embodiments are possible.

In an example use scenario, a user may select a first icon 108 to “open” electronic content, such as an electronic book. This being an example, it will be appreciated from the following that any type or form of electronic content may be employed to implement aspects of the present disclosure. In the example embodiment, however, a first particular Chinese word or phrase 110 may be displayed within or by the interface 100 in response to the selection of the first icon 108. In other embodiments, multiple Chinese words or phrases may be displayed within or by the interface 100 in response to the selection. For example, a sentence, paragraph, etc., may be displayed within or by the interface 100 in response to the selection. Moreover, in event of “initial” access of the electronic book, the first phrase 110 may correspond to a “first” word of the electronic book. Alternatively, in event of “subsequent” access of the electronic book, the first phrase 110 may correspond to a particular word last displayed prior to a previous “close” of the electronic book. Still other embodiments are possible. For example, the user may “open” the electronic book and search for and access a particular word, phrase, or passage of the electronic book.

One or more other icons may be displayed within or by the interface 100 as well. For example, a second icon 112 may be displayed within or by the interface 100 when the electronic book includes an index. In this example, a user may select the second icon 112 to access the index, which may then be displayed, at least in part, within or by the interface 100. In another example, a third icon 114 may be displayed within or by the interface 100 when the electronic book includes a glossary. In this example, a user may select the third icon 114 to access the glossary, which may then be displayed, at least in part, within or by the interface 100. Other embodiments are possible.

In addition to the icons 108, 112, and 114, and the first phrase 110, a first graphic 116 may be displayed within or by the interface 100. In one embodiment, the first graphic 116 may be associated with the electronic book in its entirety. For example, the first graphic 116 may correspond to “cover art” of the electronic book. In another embodiment, the first graphic 116 may be associated with a particular page of the electronic book. For example, the first graphic 116 may correspond to an illustration that is associated with a page of the electronic book that includes the first phrase 110, when or as displayed within or by the interface 100. Other embodiments are possible.

As mentioned above, a user may select the first icon 108 to “open” the electronic book, where the first phrase 110 may be displayed within or by the interface 100 in response to the selection. In example embodiments, the user may further navigate the electronic book to explore other Chinese words or phrases. For example, referring now additionally to FIGS. 2-4, a user may select an advance icon 118 displayed within or by the interface 100 to access a “subsequent” Chinese word or phrase when applicable. Alternatively, a user may select a return icon 120 displayed within or by the interface 100 to access a “previous” word or phrase when applicable.

In particular, FIG. 2 shows a second example screenshot 122 of the interface 100. In this example, a user may select the advance icon 118 as shown within the first screenshot 102 of FIG. 1 to access features of the interface 100 as shown in FIG. 2. For example, as shown in FIG. 2, a second particular Chinese word or phrase 124 may be displayed within or by the interface 100 in response to the selection the advance icon 118 shown in FIG. 1. Additionally, a second graphic 126 may be displayed within or by the interface 100 in response to the selection the advance icon 118 shown in FIG. 1. Here, the second graphic 126 may replace the first graphic 116 shown in FIG. 1, and the second phrase 124 may be “next” in sequence within the electronic book immediately following the first phrase 110. Similarly, a user may select the return icon 120 as shown within the second screenshot 122 of FIG. 2 to access features of the interface 100 as shown in FIG. 1. Alternatively, a user may select a home icon 128 as shown within the second screenshot 122 of FIG. 2 to access features of the interface 100 as shown in FIG. 1. In this example, “home” may be considered a first word or phrase (e.g., first phrase 110) of the electronic book. Other embodiments are possible.

FIG. 3 shows a third example screenshot 130 of the interface 100. In this example, a user may select the advance icon 118 as shown within the second screenshot 122 of FIG. 2 to access features of the interface 100 as shown in FIG. 3. For example, as shown in FIG. 3, a third particular Chinese word or phrase 132 may be displayed within or by the interface 100 in response to the selection the advance icon 118 shown in FIG. 2. Additionally, a third graphic 134 may be displayed within or by the interface 100 in response to the selection the advance icon 118 shown in FIG. 2. Here, the third graphic 134 may replace the second graphic 126 shown in FIG. 2, and the third phrase 132 may be next in sequence within the electronic book following the second phrase 124. Similarly, a user may select the return icon 120 as shown within the third screenshot 130 of FIG. 3 to access features of the interface 100 as shown in FIG. 2. Alternatively, in some embodiments, a user may select the home icon 128 as shown within the third screenshot 130 of FIG. 3 to access features of the interface 100 as shown in FIG. 1.

FIG. 4 shows a fourth example screenshot 136 of the interface 100. In this example, a user may select the advance icon 118 as shown within the third screenshot 130 of FIG. 3 to access features of the interface 100 as shown in FIG. 4. For example, as shown in FIG. 4, a fourth particular Chinese word or phrase 138 may be displayed within or by the interface 100 in response to the selection the advance icon 118 shown in FIG. 3. In this example, the fourth phrase 138 may correspond to a “last” word of the electronic book, and thus the fourth screenshot 136 of FIG. 4 does not indicate presence of the advance icon 118. Additionally, a fourth graphic 140 may be displayed within or by the interface 100 in response to the selection the advance icon 118 shown in FIG. 3. Here, the fourth graphic 140 may replace the third graphic 134 as shown in FIG. 3, and the fourth phrase 138 may be next in sequence within the electronic book following the third phrase 132. Similarly, a user may select the return icon 120 as shown within the fourth screenshot 136 of FIG. 4 to access features of the interface 100 as shown in FIG. 3. Alternatively, in some embodiments, a user may select a home icon 128 as shown within the fourth screenshot 136 of FIG. 4 to access features of the interface 100 as shown in FIG. 1.

As mentioned above, a particular user or Chinese language learner may interact with the interface 100 to selectively study both Chinese characters and Chinese terms or phrases within a single, interactive computing environment. In example embodiments, the user may pause on a particular Chinese word or phrase as displayed within or by the interface 100 to study the particular word or phrase. For example, referring now to the FIGS. 5-6, a user may select a particular character of a displayed Chinese word or phrase and, in response to the selection, at least one icon may be displayed within or by the interface 100 to enable the user to study the displayed Chinese word or phrase, as well as study characters that form the word or phrase.

In particular, FIG. 5 shows a fifth example screenshot 142 of the interface 100. In this example, the fifth screenshot 142 shows at least the first phrase 110, as shown within the first screenshot 102 of FIG. 1, displayed within or by the interface 100. FIG. 6 shows a portion 144 of the fifth screenshot 142. The portion 144 shows the first phrase 110 along with a plurality of phrase control icons including a first phrase control 146, a second phrase control 148, a third phrase control 150, a fourth phrase control 152, and a fifth phrase control 154 that is in this example depicted as a “scissors” icon. In this example, the plurality of phrase control icons may be rendered or otherwise displayed within or by the interface 100 in response selection of a particular character of the first phrase 110 within the interface 100. For example, a user may select one of a first character 156, a second character 158, and a third character 160 of the first phrase 110 within the interface 100 via “point and click” action, or “touch-input” or gesture, in a manner such as described above. In response to the selection, the first phrase control 146, second phrase control 148, third phrase control 150, fourth phrase control 152, and fifth phrase control 154 may be displayed within or by the interface 100.

The first phrase control 146, second phrase control 148, third phrase control 150, fourth phrase control 152, and fifth phrase control 154 may permit a user to study the first phrase 110, along with the first character 156, second character 158, and third character 160 of the first phrase 110. For example, a user may select the first phrase control 146 to “hear” the first phrase 110 read aloud, in Chinese. In this example, the device 104 may be configured to exhibit at least one speaker, and generate sound in accordance with tonal aspects of the first phrase 110 in response to selection of the first phrase control 146. Here, the Chinese language learner may at least benefit from “hearing” proper pronunciation of the first phrase 110.

In another example, a user may select the second phrase control 148 to “see” translation of the first phrase 110, in the English. For example, referring now to FIG. 7, the fifth screenshot 142 of the interface 100 of FIG. 5 is shown including a “pop-up” graphic 162 that displays translation of the first phrase 110, in the English, as “Little Mouse.” Here, the Chinese language learner may at least benefit from “seeing” a translation of the first phrase 110.

In another example, a user may select the third phrase control 150 to “see” a Pinyin representation of the first phrase 110. For example, referring now to FIG. 8, the fifth screenshot 142 of FIG. 5 is shown including a modification of the first phrase 110 to a Pinyin representation 164 of the first phrase 110. In the present example, the Chinese language learner may at least benefit from “seeing” a transcription of the first character 156, second character 158, and third character 160 of the first phrase 110 in Latin script.

In the example of at least FIG. 8, a user may select the fourth phrase control 152 to return to display of the first phrase 110 within or by the interface 100. In this manner, the third phrase control 150 and the fourth phrase control 152 may function in a manner similar to the advance icon 118 and the return icon 120 as described above. However, other embodiments are possible. For example, in addition to display of the first phrase 110, and the Pinyin representation of the first phrase 110, as shown in FIGS. 5-8, a user may continue to select at least one of the third phrase control 150 and the fourth phrase control 152 to “see” an English translation of each of the first character 156, second character 158, and third character 160 of the first phrase 110, much like or similar to the Pinyin representation 164 shown in FIG. 8.

In another example, a user may continue to select at least one of the third phrase control 150 and the fourth phrase control 152 to “see” a traditional representation of at least one of the first character 156, second character 158, and third character 160 of the first phrase 110, much like or similar to the Pinyin representation 164 shown in FIG. 8. In another example, a user may continue to select at least one of the third phrase control 150 and the fourth phrase control 152 to “see” pronunciation symbols of at least one of the first character 156, second character 158, and third character 160 of the first phrase 110, much like or similar to the Pinyin representation 164 shown in FIG. 8. Still other embodiments are possible.

In these examples, the first character 156, second character 158, and third character 160, as well as other above-mentioned features, may be envisioned as being imprinted on a particular side of a 6-sided cube. For example, as shown in FIG. 6, the first character 156 may be envisioned as being imprinted on a particular side of a first cube 157, the second character 158 may be envisioned as being imprinted on a particular side of a second cube 159, and the third character 160 may be envisioned as being imprinted on a particular side of a third cube 161. Continuing with this example, as shown in FIG. 8, the Pinyin representation of the first character 156 may be envisioned as being imprinted on another particular side of the first cube 157, the Pinyin representation of the second character 158 may be envisioned as being imprinted on another particular side of the second cube 159, and the Pinyin representation of the third character 160 may be envisioned as being imprinted on another particular side of the third cube 161, and etc.

In example embodiments, a “valid” linguistic phrase comprising at least two symbols or characters arranged in a particular sequence may be shown or otherwise displayed within the interface 100 by “cubes” that are adjacent or touching each other. A phrase or word may be considered “valid” when the phrase exists in a particular language. For example, as shown in FIG. 6, the first cube 157, second cube 159, and third cube 161 are depicted as adjacent or touching each other in a particular sequence such as to form the first phrase 110, in the Chinese language. In contrast, and as described in further detail below, an “invalid” linguistic phrase comprising at least two symbols or characters arranged in a particular sequence may be shown or otherwise displayed within the interface 100 by “cubes” that are separated, or disjoint, not touching each other. A phrase or word may be considered “invalid” when the phrase does not exist in a particular language. Other embodiments are possible.

As mentioned above, the fifth phrase control 154, in addition to the first phrase control 146, second phrase control 148, third phrase control 150, fourth phrase control 152, may be displayed within or by the interface 100 in response to selection of at least one of the first character 156, second character 158, and third character 160 of the first phrase 110. In accordance with the present disclosure, a user may select the fifth phrase control 154 to “split” the first phrase 110 into its constituent characters, namely the first character 156, second character 158, and third character 160, such that the same may be studied in detail. This may be consistent with the depiction of the fifth phrase control 154 as a “scissors” icon, because a user may “cut” apart or “separate” a particular to further study particular constituent symbols or characters.

For example, referring now to FIG. 9, a sixth example screenshot 166 of the interface 100 is shown including the first character 156, second character 158, and third character 160 of the first phrase 110 arranged in a separated or disjoint orientation 168 with respect to one another. In this manner, the first phrase 110 may be obscured, at least because the first character 156, second character 158, and third character 160 are no longer arranged adjacent each other forming the first phrase 110, such as shown in at least FIG. 6. In this example, it is contemplated that the first character 156, second character 158, and third character 160 when arranged adjacent each other forming the first phrase 110 may, in response to selection of the fifth phrase control 154, be split apart, standalone, within the interface 100 such as shown in FIG. 9.

Additionally, much like rolling dice, the first character 156, second character 158, and third character 160 as displayed within the interface 100 may “roll” around within the interface 100 for a predetermined time period (e.g., about 2-4 seconds) and then come to “rest” in a random position as displayed within the interface 100. This is because, in one embodiment, the first character 156 may be envisioned as being imprinted on a particular side of the first cube 157, the second character 158 may be envisioned as being imprinted on a particular side of the second cube 159, and the third character 160 may be envisioned as being imprinted on the particular side of a third cube 161 as described above. Subsequently, a user may selectively interact with the first character 156, second character 158, and third character 160, to study these respective characters in detail. Such an implementation may be beneficial in many respects.

For example, one example tendency of a Chinese language learner may be to solely study common Chinese terms or phrases to obtain conversational and/or written proficiency, in attempt to “shortcut” study of a large number of Chinese characters. The example interface 100 of the present disclosure may cater to this tendency. For example, the interface 100 may enable the Chinese language learner to initially study Chinese terms or phrases in a manner such as described above. However, the interface 100 may further provide a mechanism for the Chinese language learner to study constituent characters of Chinese terms or phrases in detail. Accordingly, the Chinese language learner may avoid some of the shortcomings of the “shortcut.” For example, the Chinese language learner may be exposed to the historical and cultural meaning of a particular Chinese character used to form a particular phrase. Additionally, with at least a minimal understanding of particular Chinese characters, the learner may be more likely to determine the meaning of an unfamiliar Chinese word.

Other benefits and/or advantages associated with the example interface 100 may be understood from the above-description provided in connection with FIGS. 1-9, and from the below-description provided in connection with FIGS. 10-21.

For example, and as mentioned above, a user may select the fifth phrase control 154 to “split” the first phrase 110 into its constituent characters, namely the first character 156, second character 158, and third character 160. Referring now to FIGS. 10-11, the user may pause on at least one of the first character 156, second character 158, and third character 160 to study the same at length and in detail.

In particular, FIG. 10 shows a seventh example screenshot 170 of the interface 100 including the first character 156, second character 158, and third character 160 of the first phrase 110 arranged in a separated or disjoint orientation 172 with respect to each other as displayed within or by the interface 100. FIG. 11 shows a portion 174 of the example seventh screenshot 170 of FIG. 10. In particular, the portion 174 shows the first character 156 along with a plurality of character control icons including a first character control 176, a second character control 178, a third character control 180, a fourth character control 182, a fifth character control 184, and sixth character control 186.

In this example, the plurality of character control icons may be rendered or otherwise displayed within or by the interface 100 in response selection of the first character 156 within the interface 100. For example, a user may select the first character 156 within the interface via “point and click” action, or “touch-input” or gesture, such as described above. In response to the selection, the first character control 176, second character control 178, third character control 180, fourth character control 182, fifth character control 184, and sixth character control 186 may be displayed within or by the interface 100 in association with the first character 156. A similar action or procedure may be performed in conjunction with selection of the second character 158, and the third character 160.

In the example shown, the first character control 176, second character control 178, third character control 180, fourth character control 182, fifth character control 184, and sixth character control 186 may permit a user to study the first character 156 in detail. For example, a user may select the first character control 176 to “hear” the first character 156 read aloud, in Chinese. Here, the Chinese language learner may at least benefit from “hearing” proper pronunciation of the first character 156. In another example, a user may select the first character control 176 to “hear” the first character 156 read aloud, in English, which may refer to “hearing” the pronunciation of the Romanization (e.g., pinyin, etc.) of the first character 156.

In another example, a user may select the second character control 178 to “see” a translation of the first character 156, in the English. For example, referring now to FIG. 12, the seventh screenshot 170 of the interface 100 of FIG. 10 is shown including a “pop-up” graphic 188 that displays translation of the first character 156, in the English, as “Little; Small; etc.” Here, the Chinese language learner may at least benefit from “seeing” a translation of the first character 156.

In another example, a user may select the third character control 180 to “see” a Pinyin representation of the first character 156. For example, referring now to FIG. 13, the seventh screenshot 170 of the interface 100 of FIG. 10 is shown including a modification of the first character 156 to a Pinyin representation 190 of the first character 156. In the present example, the Chinese language learner may at least benefit from seeing a transcription of the first character 156 in Latinized script.

In the example of at least FIG. 13, a user may select the fourth character control 182 to return to display of the first character 156 within or by the interface 100. In this manner, the third character control 180 and the fourth character control 182 may function in a manner similar to the third phrase control 150 and the fourth phrase control 152 as described above. However, other embodiments are possible. For example, a user may continue to select at least one of the third character control 180 and the fourth character control 182 to “see” an English translation of the first character 156, much like or similar to the Pinyin representation 190 shown in FIG. 13.

In another example, a user may continue to select at least one of the third character control 180 and the fourth character control 182 to “see” a traditional Chinese representation of the first character 156, much like or similar to the Pinyin representation 190 shown in FIG. 13. In another example, a user may continue to select at least one of the third character control 180 and the fourth character control 182 to “see” pronunciation symbols of the first character 156, much like or similar to the Pinyin representation 190 shown in FIG. 13. Still other embodiments are possible.

As mentioned above, the fifth character control 184 and sixth character control 186, in addition to the first character control 176, second character control 178, third character control 180, fourth character control 182, may be displayed within or by the interface 100 in response to selection of the first character 156. In accordance with the present disclosure, a user may select the fifth character control 184 to show a stroke animation of the first character 156. For example, referring now to FIG. 14, the seventh screenshot 170 of the interface 100 of FIG. 10 is shown including a “pop-up” graphic 192 that displays an active simulation of movement in drafting the first character 156. In this example, at least one of the interface 100 and the device 104 may be configured to generate and render the stroke animation of the first character 156 in accordance with a writing technique used to draft the first character 156, in response to selection of the fifth character control 184. Here, the Chinese language learner may at least benefit from seeing proper stroke technique for drafting the first character 156.

In another example, a user may select the sixth character control 186 to access a recommended word list including at least one phrase or word that may formed using at least two of the first character 156, second character 158, and third character 160 as displayed within or by the interface 100. For example, referring now to FIG. 15, the seventh screenshot 170 of the interface 100 of FIG. 10 is shown including a “pop-up” graphic 194 that displays a first recommended phrase 196, a second recommended phrase 198, and a third recommended phrase 200. Other embodiments are possible.

In the present example, however, the first recommended phrase 196 is formed by the first character 156 following in sequence by the third character 160, the second recommended phrase 198 is formed by the second character 158 followed in sequence by the third character 160, and the third recommended phrase 200 is formed by the first character 156 following in sequence by the second character 158 and the third character 160, which corresponds to the first phrase 110. Here, the Chinese language learner may at least benefit from seeing at least one alternative word or phrase that may be formed by using at least two of the first character 156, second character 158, and third character 160. Additionally, the Chinese language learner may explore or otherwise study at least one of the first recommended phrase 196, a second recommended phrase 198, and a third recommended phrase 200 in a manner similar to that described above in connection with the first phrase 110. This may be accomplished, for example, by selection of a particular control 202 associated with each one of the first recommended phrase 196, a second recommended phrase 198, and a third recommended phrase 200.

Other embodiments are possible with respect to exploring or otherwise studying Chinese phrases or words that may formed using at least two of the first character 156, second character 158, and third character 160 as displayed within or by the interface 100. For example, referring now to FIG. 16, an eighth screenshot 204 of the interface 100 is shown including the first character 156, second character 158, and third character 160 arranged in a separated or disjoint orientation 206 with respect to each other. In this example, it is assumed that the user previously interacted within the interface 100 via “point and click” action, or “touch-input” or gesture, to arrange the first character 156, second character 158, and third character 160 in the separated or disjoint orientation 206. In accordance with the present disclosure, the user may continue to interact within the interface 100 in attempt to form a phrase using the first character 156, second character 158, and third character 160. When the phrase is valid such as described above, the interface 100 may “snap” the first character 156, second character 158, and third character 160 together to form the attempted phrase.

For example, referring now to FIG. 17, a ninth screenshot 208 of the interface 100 is shown including the first character 156, second character 158, and third character 160 arranged in an adjacent orientation 210 with respect to each other to form the first phrase 110. In this example, it is assumed that the user continued to interact within the interface 100 as shown within the eighth screenshot 204 of FIG. 16 in attempt to form the first phrase 110 using the first character 156, second character 158, and third character 160. Subsequently, at least one of the interface 100 and device 104 may detect that the first phrase 110 forms a valid word or phrase, and then “snap” the first character 156, second character 158, and third character 160 together to form the first phrase 110. In general, the “snap” may be implemented when the first character 156, second character 158, and third character 160 are arranged in the correct sequence and are within a predetermined distance of each other. Here, the Chinese language learner may at least be notified that that the first phrase 110 forms a valid word or phrase. The learner may then selectively study, as desired, the first character 156, second character 158, and third character 160, as well as the first phrase 110 in a manner such as described above. Other embodiments are however possible.

For example, referring now to FIG. 18, a tenth screenshot 214 of the interface 100 is shown including the first character 156, second character 158, and third character 160 arranged in an offset orientation 212 with respect to each other. In this example, it is assumed that the user continued to interact with the interface 100 as shown within the eighth screenshot 204 of FIG. 16 in attempt to form the first phrase 110 using the first character 156, second character 158, and third character 160, and that the first phrase 110, for the sake of discussion, is an invalid word of phrase. Subsequently, at least one of the interface 100 and device 104 may detect that the first phrase 110 forms an invalid word or phrase, and prevent a “snap” of the first character 156, second character 158, and third character 160 to form the first phrase 110. Instead, the interface 100, for example, may arrange the first character 156, second character 158, and third character 160 in the offset orientation 212, slightly disjoint from one another. Here, the Chinese language learner may at least be notified that the first phrase 110 forms an invalid word or phrase, and continue to interact with the interface 100 to further explore possible words or phrases that may be formed by at least two of the first character 156, second character 158, and third character 160. Other embodiments are possible.

Referring now to FIG. 19, an example method 1900 is shown in accordance with the present disclosure. In general, the method 1900 may be wholly or at least partially implemented by a special-purpose computing system or device, which itself may, in some embodiments, be configured based on implementation-specific requirements or specifications. An example of such a computing device(s) is described in further detail below in connection with FIGS. 20-21.

The method 1900 may include displaying (module 1902), by the computing system or device 104, a first linguistic phrase comprising a plurality of adjacently positioned characters arranged in a first sequence. For example, the first phrase 110 may be displayed within or by the interface 100 in response to the selection of the first icon 108 displayed within or by the interface 100, such as described above in connection with at least FIG. 1. In this example, the first character 156 may be envisioned as being imprinted on a particular side of the first cube 157, the second character 158 may be envisioned as being imprinted on a particular side of the second cube 159, and the third character 160 may be envisioned as being imprinted on a particular side of the third cube 161, such as described above in connection with FIG. 6. The first cube 157, second cube 159, and third cube 161 may be arranged in sequence and “touching” each other. In this manner, the first phrase 110 may be considered as comprising a plurality of adjacently positioned characters arranged in a first sequence. Other embodiments are possible.

The method 1900 may further include displaying (module 1904), by the computing system or device 104, constituent characters of the first linguistic phrase separate from each other to obscure the first linguistic phrase. For example, a user may interact with the interface 100 and select the fifth phrase control 154 to “split” the first phrase 110 into its constituent characters, namely the first character 156, second character 158, and third character 160, such as described above in connection with at least FIG. 9. In this example, the first phrase 110 may be obscured at least because the first character 156, second character 158, and third character 160 of the first phrase 110 may be arranged in the separated or disjoint orientation 168 with respect to one another, such that the first character 156, second character 158, and third character 160 no longer form the first phrase 110. Other embodiments are possible.

The method 1900 may further include receiving (module 1906), by the computing system or device 104, a command to combine at least two of the constituent characters of the first linguistic phrase to form a second linguistic phrase comprising a plurality of adjacently positioned characters arranged in a particular sequence. For example, a user may interact with the interface 100 to form a phrase comprising the second character 158 followed in sequence by the third character 160, similar description of the second recommended phrase 198 such as described above in connection with at least FIG. 15. Other embodiments are possible.

The method 1900 may further include evaluating (module 1908), by the computing system or device 104, validity of the second linguistic phrase prior to forming the second linguistic phrase. For example, as the user interacts with the interface 100 to form the phrase comprising the second character 158 followed in sequence by the third character 160 (module 1906), the interface 100 may detect or otherwise determine that the attempted phrase either exists in the Chinese language, that is considered “valid,” or does not exist in the Chinese language, that is considered “invalid.” Other embodiments are possible.

The method 1900 may further include displaying (module 1910), by the computing system or device 104, the second linguistic phrase when determined valid. For example, as the user interacts with the interface 100 to form the phrase comprising the second character 158 followed in sequence by the third character 160 (module 1906), the interface 100 may detect or otherwise determine that the attempted phrase is valid (module 1908), and then may “snap” the second character 158 and third character 160 together to form the attempted phrase in a manner such as described above in connection with at least FIG. 17. Other embodiments are possible. For example, as the user interacts with the interface 100 to form the phrase comprising the second character 158 followed in sequence by the third character 160 (module 1906), the interface 100 may detect or otherwise determine that the attempted phrase is invalid (module 1908), and then may prevent a “snap” of the second character 158 and third character 160 together to form the attempted phrase.

Example embodiments described above refer to an English-Chinese implementation. It will be appreciated that other embodiments are possible. For example, it is contemplated that a French-Chinese, Spanish-Chinese, etc., implementation is or are consistent with the principles of the present disclosure. More specifically, it is contemplated that a LANGUAGE-Chinese implementation is consistent with the principles of the present disclosure, where the term “LANGUAGE” may refer to any communication system having at least some form of signed or writing or written system. Still further, it is contemplated that a LANGUAGE A-LANGUAGE B implementation is consistent with the principles of the present disclosure, where the term “LANGUAGE A” may refer to any first communication system having at least some form of signed or writing or written system, and the term “LANGUAGE B” may refer to any second communication system having at least some form of signed or writing or written system.

FIG. 20 shows an example networked computing environment 2000 in which aspects of the present disclosure may be implemented. The environment 2000 may include a client device 2002, a server device 2004, a storage device 2006, and a network 2008. Other embodiments are possible. For example, the environment 2000 may generally include more or fewer devices, networks, and other components as desired.

The client device 2002 and the server device 2004 may be configured as special-purpose computing devices. Generally, the server device 2004 may be configured as a business server that implements business processes, and the client device 2002 may be a programmable machine configured to enable a user to access and/or implement functionality of the server device 2004. For example, the server device 2004 may host a web service (e.g., software as a service) or web site that is accessible to the client device 2002. For example, the server device 2004 may host or otherwise implement functionality associated with the interface 100 described above in connection with FIGS. 1-19. However, other embodiments are possible. For example, in some embodiments, functionality associated with the interface 100 may wholly or at least partially be implemented on or by the client device 2002. In this example, the client device 2002 may implement functionality associated with the interface 100 while disconnected from elements of the example environment 2000, without communication with or from elements of the example environment 2000. Still other embodiments are possible.

The storage device 2006 may be an electronic data storage device, such as a relational database or any other type of persistent data storage device. The storage device 2006 may store data in a predefined format such that the server device 2004 can query, modify, and/or manage electronic data stored thereon. For example, storage device 2006 may at least store a language corpus 2010 and a lesson corpus 2012. In general, the language corpus 2010 may comprise of a very “large” and structured set of text such as, for example, all known Chinese characters, and all known Chinese words or phrases. In this example, the server device 2004 may access the language corpus 2010 to present to the client device 2002 particular Chinese characters and words or phrases for presentation within the interface 100, in manner similar to that described above in connection with FIGS. 1-19. Other embodiments are possible.

Similarly, the lesson corpus 2012 may comprise of a very “large” and structured set of text such as, for example, a plurality of electronic books. In this example, the server device 2004 may access the lesson corpus 2012 to present to the client device 2002 particular electronic books for presentation within the interface 100, in manner similar to that described above in connection with FIGS. 1-19. Additionally, the lesson corpus 2012 may contain a plurality of electronic books organized according to Chinese language learner ability. For example, the lesson corpus 2012 may contain a plurality of electronic books organized according to “beginner” Chinese language learner ability, “intermediate” Chinese language learner ability, “expert” Chinese language learner ability, etc. Such an implementation may render the interface 100 useful for Chinese language learners of all ability.

The network 2008 is a bi-directional data communication path for data transfer between one or more compatibly configured devices. In the example shown, the network 2008 may establish a communication path for data transfer between the client device 2002 and the server device 2004. Additionally, although not explicitly shown, in some embodiments the network 2008 may establish a communication path for data transfer between the server device 2004 and the storage device 2006. In general, the network 2008 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, or other any type of communication network(s) configured such that data may be transferred among respective elements of the example environment 2000.

FIG. 21 illustrates an embodiment of an example computer system or device 2100. An example of a computer device includes any type of portable computing device such as a smartphone, tablet, laptop, feature phone, personal data assistant, and other computing devices such as an enterprise server, blade server, desktop computer, gaming console, and many others. The example computer system 2100 may be configured to perform and/or include instructions that, when executed, cause the computer device 2100 to perform the example method of FIG. 19, as well as generate and support functionality of one or more interactive interfaces, such as the example interface 100 discussed in detail above. FIG. 21 is intended only to provide a generalized illustration of various components, any or all of which may be utilized as appropriate. FIG. 21 therefore broadly illustrates how individual system elements may be implemented in a relatively separated or relatively more integrated manner.

The computer system 2100 is shown comprising hardware elements that may be electrically coupled via bus 2102 (or may otherwise be in communication, as appropriate). The hardware elements may include a processing unit with one or more processors 2104, including without limitation one or more general-purpose processors and/or one or more special-purpose processors, such as digital signal processing chips, graphics acceleration processors, and/or the like; one or more input devices 2106, which can include without limitation a pointing device such as a mouse, a touchscreen comprising a touch sensitive surface having the ability, along with the computing device 2100, to recognize the presence of one or more points of contact with the surface such “point” awareness being used to implement any of a plurality of “touch-input” gestures, a keyboard, and the like; and one or more output devices 2108, which can include without limitation a presentation device (e.g., television), a printer, and/or the like.

The computer system 2100 may further include (and/or be in communication with) one or more non-transitory storage devices 2110, which can comprise, without limitation, local and/or network accessible storage, and/or can include, without limitation, a disk drive, a drive array, an optical storage device, a solid-state storage device, such as a random access memory, and/or a read-only memory, which can be programmable, flash-updateable, and/or the like. Such storage devices may be configured to implement any appropriate data stores, including without limitation, various file systems, database structures, and/or the like.

The computer device 2100 may also include a communications subsystem 2112, which can include without limitation a modem, a network card (wireless or wired), an infrared communication device, a wireless communication device, and/or a chipset (such as a Bluetooth™ device, an 2102.11 device, a WiFi device, a WiMax device, cellular communication facilities (e.g., GSM, WCDMA, LTE, etc.), and/or the like. The communications subsystem 2112 may permit data to be exchanged with a network (such as the network described below, to name one example), other computer systems, and/or any other devices described herein. In many embodiments, the computer system 2100 will further comprise a working memory 2114, which can include a RAM or ROM device, as described above.

The computer device 2100 may also comprise software elements, shown as being currently located within the working memory 2114, including an operating system 2116, device drivers, executable libraries, and/or other code, such as one or more application programs 2118, which may comprise computer programs provided by various embodiments, and/or may be designed to implement methods, and/or configure systems, provided by other embodiments, as described herein. Merely by way of example, one or more procedures described with respect to the method(s) discussed above, and/or system components might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 2110 described above. In some cases, the storage medium might be incorporated within a computer system, such as computer system 2100. In other embodiments, the storage medium might be separate from a computer system (e.g., a removable medium, such as flash memory), and/or provided in an installation package, such that the storage medium can be used to program, configure, and/or adapt a general purpose computer with the instructions/code stored thereon. These instructions might take the form of executable code, which is executable by the computer device 2100 and/or might take the form of source and/or installable code, which, upon compilation and/or installation on the computer system 2100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer device 2100) to perform methods in accordance with various embodiments of the invention. According to a set of embodiments, some or all of the procedures of such methods are performed by the computer system 2100 in response to processor 2104 executing one or more sequences of one or more instructions (which might be incorporated into the operating system 2116 and/or other code, such as an application program 2118) contained in the working memory 2114. Such instructions may be read into the working memory 2114 from another computer-readable medium, such as one or more of the storage device(s) 2110. Merely by way of example, execution of the sequences of instructions contained in the working memory 2114 might cause the processor(s) 2104 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer device 2100, various computer-readable media might be involved in providing instructions/code to processor(s) 2104 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 2110. Volatile media include, without limitation, dynamic memory, such as the working memory 2114.

Common forms of physical and/or tangible computer-readable media include, for example, a floppy disk, a flexible disk, hard disk, magnetic tape, or any other magnetic medium, a CD-ROM, any other optical medium, RAM, PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 2104 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 2100.

The communications subsystem 2112 (and/or components thereof) generally will receive signals, and the bus 2102 then might carry the signals (and/or the data, instructions, etc. carried by the signals) to the working memory 2114, from which the processor(s) 2104 retrieves and executes the instructions. The instructions received by the working memory 2114 may optionally be stored on a non-transitory storage device 2110 either before or after execution by the processor(s) 2104.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example embodiments described herein may be implemented as logical operations in a computing device in a networked computing system environment. The logical operations may be implemented as any combination of: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
displaying a linguistic phrase comprising a plurality of adjacently positioned characters arranged in a first sequence;
receiving a first command to obscure the linguistic phrase by separating the plurality of adjacently positioned characters into constituent characters;
in response to receiving the first command, displaying the constituent characters separate from each other to obscure the linguistic phrase;
receiving a second command to combine at least two of the constituent characters to form a particular linguistic phrase comprising a plurality of adjacently positioned characters arranged in a particular sequence;
evaluating validity of the particular linguistic phrase; and
upon determining that the particular linguistic phrase is valid, displaying the particular linguistic phrase comprising the plurality of adjacently positioned characters arranged in the particular sequence.

2. The method of claim 1, further comprising receiving a command to access information associated with a particular one of the constituent characters.

3. The method of claim 2, further comprising modifying the particular one of the constituent characters in response to receiving the command.

4. The method of claim 3, wherein the particular one of the constituent characters is a particular Chinese character, and modifying comprises displaying an English translation of the particular Chinese character.

5. The method of claim 3, wherein the particular one of the constituent characters is a particular Chinese character, and modifying comprises displaying a Pinyin representation of the particular Chinese character.

6. The method of claim 3, wherein the particular one of the constituent characters is a particular traditional Chinese character, and modifying comprises displaying a simplified representation of the particular traditional Chinese character.

7. The method of claim 2, wherein the particular one of the constituent characters is a particular Chinese character, and the method further comprises playing an audible Chinese pronunciation of the particular Chinese character.

8. The method of claim 2, further comprising displaying a listing comprising a plurality of valid linguistic phrases that may be formed using the displayed constituent characters in response to receiving the command.

9. The method of claim 2, wherein the particular one of the constituent characters is a particular Chinese character, and the method further comprises displaying a stroke animation for writing the particular Chinese character.

10. The method of claim 1, wherein each of the constituent characters is a particular Chinese character, and the method further comprises: receiving a command to access information associated with one of the linguistic phrase and the particular linguistic phrase; and playing an audible Chinese pronunciation of the particular Chinese character of the one of the linguistic phrase and the particular linguistic phrase.

11. A computing device, comprising:
a display device;
a non-transitory computer-readable medium having sets of instructions stored thereon; and
a computer processor in communication with the display device and the non-transitory computer-readable medium, wherein the sets of instructions when executed by the computer processor, cause the computer processor to:
display, on the display device, a linguistic phrase comprising a plurality of adjacently positioned characters arranged in a first sequence;
receive a first command to obscure the linguistic phrase by separating the plurality of adjacently positioned characters into constituent characters;
in response to receiving the first command, display, on the display device, the constituent characters separate from each other to obscure the linguistic phrase;
receive a second command to combine at least two of the constituent characters to form a particular linguistic phrase comprising a plurality of adjacently positioned characters arranged in a particular sequence;
evaluate validity of the particular linguistic phrase; and
upon determining that the particular linguistic phrase is valid, display, at the display device, the particular linguistic phrase comprising the plurality of adjacently positioned characters arranged in the particular sequence.

12. The computing device of claim 11, wherein the sets of instructions when further executed by the computer processor, cause the computer processor to receive a command to access information associated with a particular one of the constituent characters.

13. The computing device of claim 12, wherein the sets of instructions when further executed by the computer processor, cause the computer processor to modify the particular one of the constituent characters in response to receiving the command.

14. The computing device of claim 13, wherein the particular one of the constituent characters is a particular Chinese character, and, wherein the sets of instructions when further executed by the computer processor, cause the computer processor to display an English translation of the particular Chinese character.

15. The computing device of claim 13, wherein the particular one of the constituent characters is a particular Chinese character, and modifying comprises displaying a Pinyin representation of the particular Chinese character.

16. A non-transitory computer-readable medium having sets of instructions stored thereon which, when executed by a computer, cause the computer to:
display a linguistic phrase comprising a plurality of adjacently positioned characters arranged in a first sequence;
identify receipt of a first command to obscure the linguistic phrase by separating the plurality of adjacently positioned characters into constituent characters;
in response to identifying receipt of the first command, display the constituent characters separate from each other to obscure the linguistic phrase;
identify receipt of a second command to combine at least two of the constituent characters to form a particular linguistic phrase comprising a plurality of adjacently positioned characters arranged in a particular sequence;
evaluate validity of the particular linguistic phrase; and
upon determining that the particular linguistic phrase is valid, display the particular linguistic phrase comprising the plurality of adjacently positioned characters arranged in the particular sequence.

17. The non-transitory computer-readable medium of claim 16, wherein the sets of instructions when further executed by the computer, cause the computer to identify receipt of a command to access information associated with a particular one of the constituent characters.

18. The non-transitory computer-readable medium of claim 17, wherein the particular one of the constituent characters is a particular Chinese character, and wherein the sets of instructions when further executed by the computer, cause the computer to play an audible Chinese pronunciation of the particular Chinese character.

19. The non-transitory computer-readable medium of claim 17, wherein the sets of instructions when further executed by the computer, cause the computer to display a listing comprising a plurality of valid linguistic phrases that may be formed using the displayed constituent characters in response to receiving the command.

20. The non-transitory computer-readable medium of claim 17, wherein the particular one of the constituent characters is a particular Chinese character, and wherein the sets of instructions when further executed by the computer, cause the computer to display a stroke animation for writing the particular Chinese character.
